(19) United States
(12) Patent Application Publication
(10) Pub. No.: US 2004/0196645 A1
(43) Pub. Date: Oct. 7, 2004

(54) Edge lit illumination devices

(76) Inventor: Heather Allinson, Darlington (GB)

Correspondence Address: VENABLE, BAETJER, HOWARD AND CIVILETTI, LLP, P.O. BOX 34385, WASHINGTON, DC, 20043-9998, US

(21) Appl. No.: 10/450,518

(22) PCT Filed: Oct. 29, 2001
(86) PCT No.: PCT/GB01/04773

(30) Foreign Application Priority Data
Dec. 21, 2000 (GB) 0031611.7

(51) Int. Cl. F21V 7/04

(52) U.S. Cl. 362/31

(57) ABSTRACT

An edge lit illumination device is described. The device has at least one light source (13, 14) and a light transmission member (10) having at least one light output surface (12) and at lest one light ingress edge substantially perpendicular to the surface. The light source (13, 14) is located adjacent to the light ingress edge so that light from the light source (13, 14) enters the transmission element (10) via the ingress edge and propagates through the member. At least one light output surface (12) is uniformly roughened across its surface. The surface (11) of the said member opposite the output surface (12) has a pattern of light diffusing elements thereon. A method of producing a light transmission member for an illumination device is also described.

The present invention relates to edge lit illumination devices and, in particular, edge lit illumination devices with roughened surfaces. Numerous applications for edge lit illumination devices are known. Edge lit illumination devices include illuminated display units or signs, lap top computer screens, LCD display back lighting, road signs, street furniture, advertising units, illuminated shelving, internal lighting of appliances such as illumination of the sides, back, or top of fridge units including display fridges, wine chillers/coolers. Edge lit illumination devices also include appliance fronts and fascias such as dial and control knob panels.

Edge lit devices utilise numerous light sources including planar light sources and curved light sources.

Generally, the illumination device includes a light source located adjacent to a light transmission element. The light transmission element includes a light output surface and at least one light ingress edge adjacent to the light source so that light from the light source enters the transmission element via the said edge to propagate through the element.

Many attempts have been made at modifying the roughening at the surface of the light transmission element so that the light propagating through the transmission element escapes through the surface in accordance with the modification. The light transmission element typically acts as a display window with the material to be displayed located behind, in front of, or on the actual surface itself.

For instance, DE 2356947 discusses the possibility of providing what is said to be finely roughened or frosted parts of the surface. However, the fine roughening is employed so as to avoid the possibility of coarse roughening impairing the transparency of the unit. The light output of this material is discussed in DE 3223706 and is said to be insufficiently uniform across the sheet so that increasing density of roughness with increasing distance from the light source is required.

DE3223706 discloses the benefit of increasing the density of roughening with increasing distance from the light source in order to increase output which naturally falls across the plate.

U.S. Pat. No. 4,385,343 discloses an edge lit product, including acrylic material as the light transmitting body, which has both surfaces of the light transmitting body roughened. The distribution of the light on the light egress face surface can be attained by selecting an appropriate angular relation between the backing material reflecting surface and the surface of the sheet when they are spaced apart or by tapering of the light transmitting body which is convergent in the direction away from the light ingress edge surface. Plane parallel faces are also described. The document indicates that the plane parallel faces arrangement of FIG. 7 is only adequate if the edge lit sign is relatively small. The method of application of the roughness is by abrasion using a flapper wheel with strips of sandpaper attached or by cutting the surface of the transparent plate. The cutting device is said to give a cut into the surface of the transparent material between 5/1000 of an inch and 100/1000 of an inch. The document indicates that there is a falling away of light with distance from the light source and that the solution to this problem is to vary the thickness or to converge the plate with increasing distance. It also discusses the possibility of angling the plate if spaced from the light source.

U.S. Pat. No. 3,497,981 solves the problem of light egress in a similar manner to U.S. Pat. No. 4,385,343. The manner by which the roughness is applied to the rod includes chemical etching as well as sandblasting. The document discloses that it is necessary to use differential etching in order to have sufficient light output in anything other than small letters.

U.S. Pat. No. 5,625,968 does not relate to surface roughness but the application of a dot matrix pattern to allow egress of light from within the sheet. The dot matrix pattern is preferably of increasing density towards the centre of the sheet and away from the light source.

GB 2161309A again solves the problem of light egress by increasing the coarseness of the roughness away from the light source.

GB 2211012 discloses an edge illuminated display aid which includes the display element 63 of transparent material to produce a scattering, which treatment is intentionally increased in severity or optical density with increasing distance from the light source 62.

GB 2164138 relates to a light diffusing device and an illumination apparatus employing the light diffusing device. The diffusing layers are provided with thicknesses which are different from each other or, otherwise, arranged to have a density which varies along the device, thereby illuminating a desired object uniformly as a whole.

UK 2196100 discloses a light diffusing device which includes a light diffusion layer 3 but also a light reflecting film 7 which decreases reflectivity with increasing distance from the light source b, c and thereby provides an even distribution of light from the light diffusion layer 3 on to the light diffusing plate 6. The document discusses the problem with edge lit frosted glass plates or opal glass plates in that they fail to evenly illuminate the entire surface of the light diffusing plate.

U.S. Pat. No. 4,059,916 relates to edge lit products with a roughened rear surface and a reflecting layer generally against the rear surface. The effect of the roughened surface is to increase the light reflected through the front surface. The roughening is described as grooves and ridges across the surface. The document discusses the advantages in thinning the sheet with increasing distance from the light source.

PCT WO84/04838 discloses a display device whereby both the upper and lower surfaces may be roughened by nailing, blasting or stamping. The document also addresses the problem of decreasing light with increasing distance from the light source and this problem is solved by using a convex rear surface so that the plate is progressively thinner with increasing distance from the light source.

EP 0561329 This document discloses an edge lit light display device having light sources along all four side edges. The document also envisages the possibility that the density of the roughness of the dots applied to the surface may be uniform in one direction. The document teaches that it is necessary to have variation in density in the other direction in order to have uniform brightness.

U.S. Pat. No. 5,649,754 discloses a combination of two types of roughening. It also discloses the possibility that there is an underlying uniform roughness. To solve the problem of achieving uniform brightness across the surface, a further layer is applied to the uniform layer. The document discloses that the roughness may be applied by sandblasting and is thus relatively coarse.

The above documents show a clear trend towards the provision of either varying density surface features to provide uniform brightness across the light output surface or varying transmission plate thickness to maintain light output. Such techniques are difficult and expensive to apply to the surface or the sheet. Furthermore, each application requires its own optical characteristics and, therefore, in the case of density variations, it is necessary to specifically vary the roughness density in relation to specific products. Accordingly, each product is typically customised thus further increasing expense.

Another way of treating the surface is by application of a matrix of light reflecting and scattering material either directly to the surface or to a transparent film which is then adhered to the surface as disclosed in EP-A-0549679. In this application the light reflecting material is in the form of dots which may be etched, painted or screen printed directly on to the surface of the light transmitting sheet or that of the transparent film adhered to the surface. The density of these dots may be increased in the direction away from the edge at which the light source is fixed by increasing the number of dots per unit area and decreasing the gaps between them or by keeping the gaps between the dots the same and increasing the size of the dots. Although screen printing is expensive, it is a commonly used method and employed throughout the industry. Much work has gone into its improvements. Varying density roughness is also used in some of the applications mentioned hereinbefore and has been used for many years.

According to a first aspect of the present invention there is provided an edge lit illumination device comprising at least one light source;

a light transmission member having at least one light output surface and at least one light ingress edge substantially perpendicular to said surface, the light source being located adjacent to said light ingress edge so that light from the light source enters the transmission element via the said edge and propagates through the said member, the said at least one light output surface being uniformly roughened across the output surface, wherein the surface of the said member opposite the output surface has a pattern of light diffusing elements thereon.

Preferably, the said surface of the opposite side of the light transmitting sheet has light diffusing elements as a pattern of discrete markings extending across the surface thereof. The markings may extend across all or a part of the said surface.

Advantageously, by using markings on the opposite surface and a rough surface on the light output surface, fewer light diffusing elements than would otherwise be needed result in the modification of light output required. Alternatively, better results are obtained with the same level of light diffusing elements as prior art sheets. By the application of fewer light diffusing elements, production costs are not only reduced but the visual appearance of the sheet improves because some light diffusing element markings may be visible to the observer and a high density of markings can therefore affect the visual appearance of the sheet. Accordingly, by use of the invention, a lower density of such markings is possible for some applications. Furthermore, although uniform rough surfaces are more easily applied to sheet, the fine tuning of light output is usually achieved by varying the density of the roughness as a function of distance from the light source. Such density variations are expensive to produce compared with the application of uniform density roughness. However, by combining uniform density roughness with markings on the opposite surface, the markings can produce the required modifications to the light output. Surprisingly, the markings and the surface roughness combine in a complimentary manner to produce strong and even light output across the surface.

The level of surface area coverage by the discrete markings on the said opposite side surface is preferably 0.1 to 99% of the total opposite surface, more preferably 0.5 to 50% and most preferably 1.0 to 20%. An especially preferred range is 3-10%. The level of coverage within a specific nominal or predefined area of the overall surface may be 0%-100%, more preferably, 0-50%, most preferably 0-30%. An especially preferred range is 0-20%. The markings may be of any shape, for example square, round, rectangular, triangular or irregular. Preferably, they are round or irregular shape, for example irregularly shaped generally elongated structures based on squares and/or rectangles. The markings may be of equal size or a variety of sizes preferably ranging from 0.001 mm-20 mm in widest dimension/diameter, more preferably 0.01 to 5 mm, most preferably 0.1-3 mm. Preferably, the density of markings is increased in a direction away from the edge of the light transmitting sheet at which the light source is positioned. Generally, the density of markings can be increased/decreased by increasing/decreasing the size of the markings and/or the number of markings. The markings can be translucent or opaque and are preferably light coloured. By translucent we mean capable of transmitting rays of light with diffusion also. By opaque we mean substantially incapable of transmitting light. These markings may be etched, painted or screen printed directly on to the surface of the light transmitting sheet or to that of a transparent film which is itself then adhered to the surface. Preferably, the markings are screen printed directly on to the surface of the light transmitting sheet. An example of screen printing is stochastic screen printing.

Edge-lit illumination systems described in the present invention can be used as lighting devices or light sources as well as advertising displays and also may be modified for use as illuminated shelving, for example in refrigerators.

The extent of the distribution of the markings may encompass substantially all of the surface of the said opposite surface or a defined area of the surface. For example, there may be areas of the said opposite surface free from the said markings. In such embodiments, the marked area may be of a predetermined outline. The said outline may be determined, for instance, by the length, output strength or performance characteristics of the illumination device and/or the light required. Accordingly, the marked area may form a sub-area within the total area of the said opposite surface of the sheet.

Preferably, the roughening is not applied to the said opposite surface. Preferably, the surface of the opposite surface is a gloss surface.

According to a second aspect of the present invention there is provided a method of producing a light transmission member for an illumination device comprising the steps of:—

(a) forming the said member,

(b) applying roughening to the output surface and

(c) applying light diffusing elements to the rear surface.

Steps (a) and (b) may be carried out simultaneously.

Preferably, the roughening is sufficiently fine to give an average Ra value across the output surface of less than 1.0 μm/mm thickness of the element.

Preferably, the roughening is sufficiently fine to give drop-off of light output across the output surface of less than 5000 lux. By drop-off is meant the difference between the measured maximum and the measured minimum. It should be borne in mind that the measured maximum is generally taken at the minimum possible measurable distance from the edge (measurement at the edge itself is not measurable due to the minimum distance required by the measurement device). The measure minimum is usually taken at the maximum distance from a light source.

Preferably, the average Ra value across the surface is less than 1.0 μm/mm thickness of the element.

By uniformly roughened is meant that the level of roughness does not generally increase or decrease with increasing distance from the light source. However, there may be small localised variance in the roughness within a nominal area due to the inherent variance in the process or the means by which roughness is applied. However, such variance would be random and would exist across the whole surface and would not create any particular trend across the whole of the output surface.

Preferably, the transmission element maintains substantially uniform thickness with increasing distance from the light source.

Typically, the average Ra value across the output surface of the transmission element, is less than 0.75 μm/mm thickness, more preferably less than 0.40 μm/mm thickness, most preferably less than 0.30 μm/mm thickness. Especially preferred average Ra values for rough surfaces on transmission elements are less than 0.20 μm/mm.

Preferably, the average Ra value across the surface of the roughened transmission element is found within the range 0.01-1.0 μm/mm thickness of element, more preferably 0.02-0.75 μm/mm thickness of element, most preferably 0.02-0.40 μm/mm thickness of element. Especially preferred is an average Ra value in the range 0.05-0.30 μm/mm.

For example, on a 10 mm thick sheet the average Ra value may be 1.8 μm, whereas equivalent uniformity of output with a 5 mm thick sheet may be obtained with an average Ra value of 0.9 μm. In both cases, the average Ra value would be 0.18 μm/mm thickness of sheet.

In addition to roughening of the output surface, a reflector adjacent to the opposite surface, to redirect light to an output surface is also envisaged.

Localised fluctuation in the output surface Ra value may be between 0.01 μm-1.0 μm, preferably, between 0.05 μm-1.0 μm, more preferably 0.1 μm-0.8 μm, most preferably, 0.2 μm-0.6 μm. For example, the surface roughness may be between 0.9-1.3 μm for a surface having 5-10 mm thickness. However, if the average surface roughness is 1.1 μm, this will be so across the surface and any fluctuation will be substantially random and will not create a defined variation in density across the surface.

In addition, a plurality of sheets may be in superposed relationship and roughening may be applied to the output faces of the superposed sheets, the inner mating faces having the light diffusing elements thereon.

Preferably, the drop-off of light output across the output surface is less than 4000 lux, more preferably, less than 3000 lux, most preferably less than 2000 lux.

Preferably, the initial drop-off measurement is taken from a position of at least 50 mm in from the edge of the element, more preferably, at least 100 mm in from the edge, most preferably at least 150 mm in from the edge of the element. The final reading may be taken from equivalent points in relation to the opposite edge of the element. However, the drop-off is the measured fall in light output from the initial measurement to the output low-point across the sheet.

In a single light source edge lit product, this low point will be where the final measurement is made at the opposite edge of the element but in a multiple light source edge lit product, the low point will typically be that point most distant from the edges where the light sources are formed and this will typically be in the middle of the element, assuming equivalent output edge lights. It is envisaged that the drop-off may be negligible and may also be negative so that an increase in light output is found across the sheet with increasing distance from the light source.

Preferably, the transmission element is a sheet of, preferably, transparent material although optionally, translucent material.

Typically, the transmission element is a rectangular sheet which may be square. However, the sheet may be of any shape, for example round, square, rectangular, triangular, cylindrical, irregular.

The sheet may be made from glass or any suitable plastic material, preferably acrylic material is used, or optionally a polycarbonate material is used. Preferred materials may be selected from polymethyl methacrylate, polyethyl methacrylate, polypropyl methacrylate, polybutyl methacrylate, polyglycidyl methacrylate, polyisobornyl methacrylate, polycyclohexyl methacrylate either as homopolymers or as copolymers of at least one preceding polymer including such copolymers containing a minor proportion of another monomer selected from at least one C₁-₄ alkyl acrylate. Preferably, polymethyl methacrylate is used.

Preferably, the transmission element is less than 3000 mm in the dimension perpendicular to or away from the light source edge, more preferably, less than 2000 mm in this width dimension, most preferably, less than 1500 mm in this width dimension.

Preferably, the transmission element is less than 100 mm in thickness, more preferably, less than 50 mm in thickness most preferably, less than 30 mm in thickness.

Typically, the range of thicknesses of the transmission element is 1-100 mm, more preferably, 1-50 mm, most preferably, 3-25 mm.

Methods of making the transmission element include cast polymerisation, moulding, extrusion and embossing and coextrusion.

The embossing of an extrusion sheet may take place during or after manufacture. Roughening on the surface layer of the co-extruded material may be effected by suitable matting or gloss-control agents. Suitable matting or gloss-control agents to cause roughening on the surface layer of co-extruded material are known in the art of co-extruded materials.

Preferably, the transmission element corresponds to the length of the light source in the dimension parallel with the light source or along the light source edge of the element. The transmission element may also be marginally longer than the light source in this dimension. Preferably, the light source is elongate. In such cases, the dots may be intensified in areas where light output requires intensification due to the light source position. For instance, in the case of light sources which are shorter than the adjacent edge of the sheet, the areas above and below the opposite ends of the light source may require a high intensity dot pattern as well as the central area of the sheet away from the light source.

Typically, the transmission element is between 100 mm and 3000 mm long in the dimension perpendicular to or away from the light source edge, more preferably between 200 mm and 2000 mm long in this dimension, most preferably between 300 mm and 1500 mm long in this dimension. Especially preferred is a width in this dimension of between 400 and 1200 mm.

Usage for the invention includes illuminated display units or signs including lap top computer displays and LCD display back lighting, road signs, street furniture, advertising units, appliance fronts and fascias, such as dial and control knob panels, internal lighting of appliances such as illumination of sides, back and top of fridge units, display fridges, wine chillers and coolers.

The light sources may be straight or curved as may the edges of the transmission element. Preferably, the light sources are planar. Any suitable light source may be used but suitable light sources include fluorescent tubes, cold cathode tubes, neon tubes, LEDs conventional and organic, fibreoptics and light bulbs.

Preferably, fluorescent tubing or LED's are used. The diameter of the fluorescent tube may vary from typically 6 mm, commonly referred to as T2, to 25 mm. The distance from the edge of the light transmitting panel to the crest of the tube is preferably between 1 and 2 mm. In an alternative embodiment the fluorescent tube is an aperture tube. This type of tube has coated on the inside wall of the glass a reflective coating with a fluorescent coating on top of it. The aperture is a part of this tube, for example 300 of the 3600 around the inside of the tube, with no coating. This opening runs the length of the tube and is arranged so it is directing light from the light source at the edge of the light transmitting sheet. A reflector is typically positioned behind each fluorescent tube and may be any material capable of reflecting light, for example mirrored aluminium. Preferably, the light transmitting sheet is in a fixed relationship to the light source.

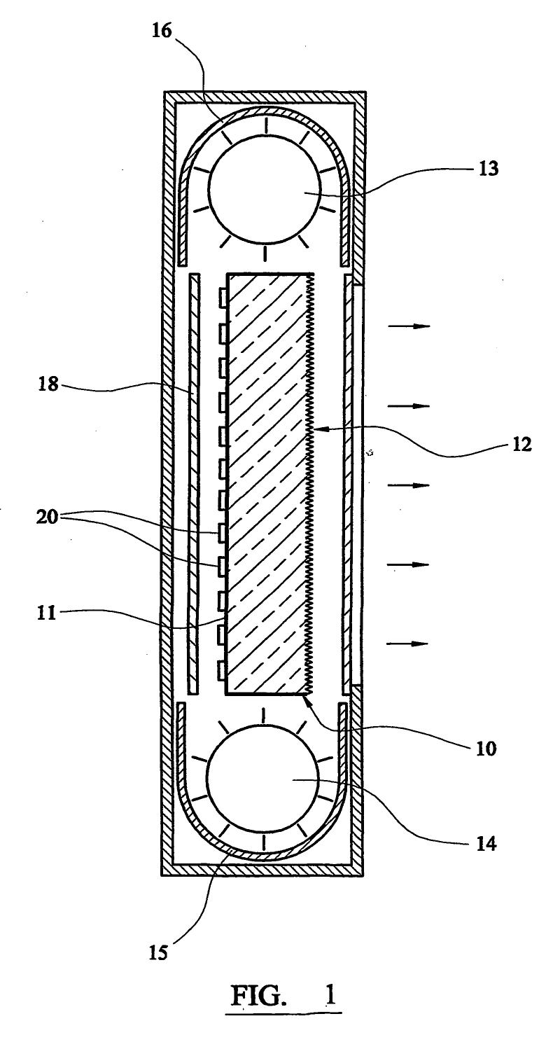

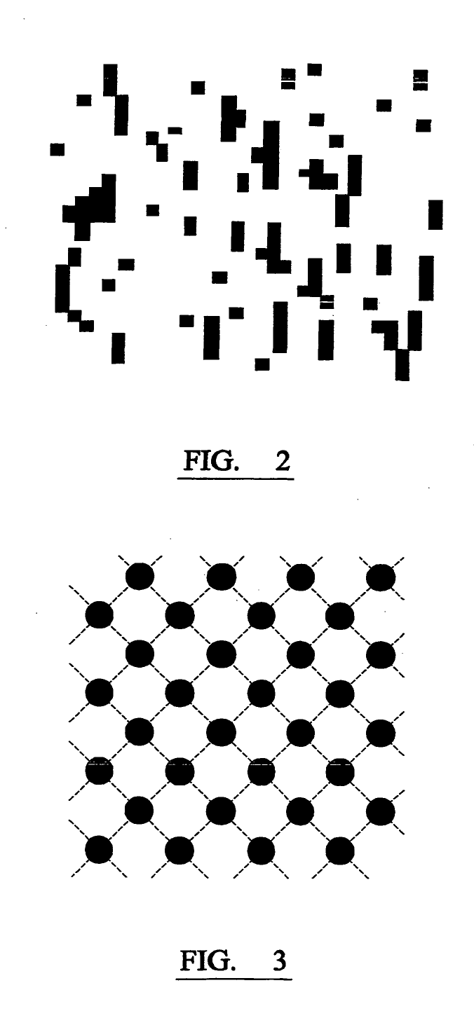

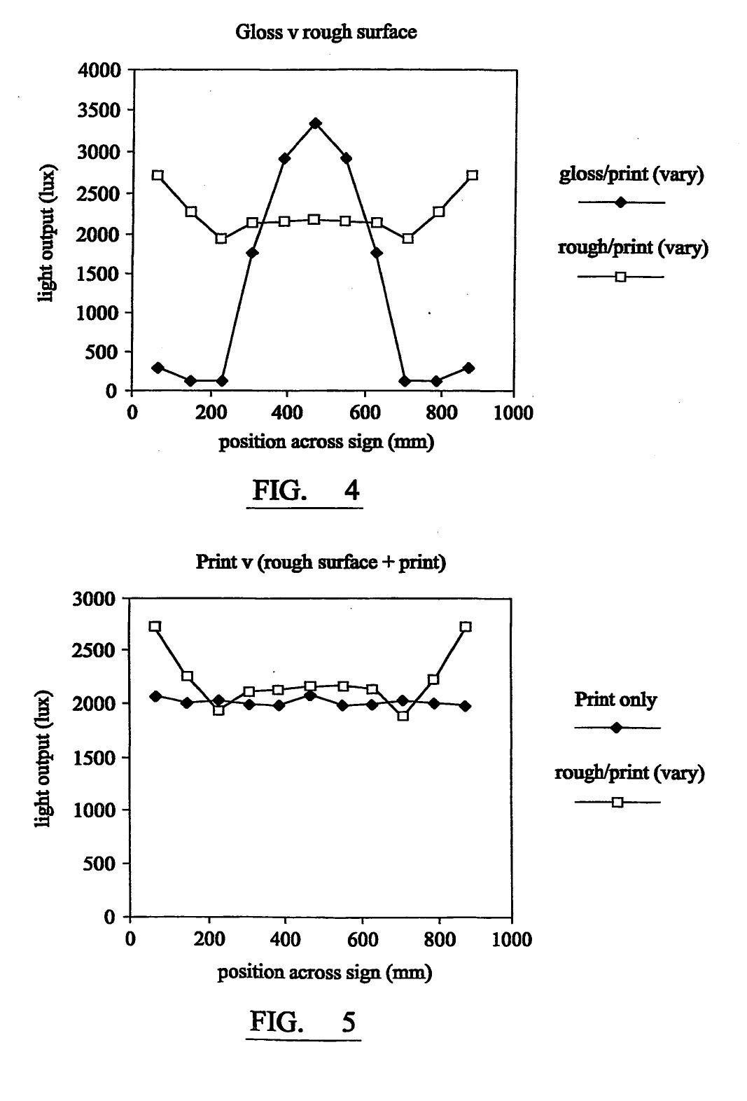

Specific embodiments of the invention will now be further described in the following examples and with reference to the accompanying drawing (FIG. 1) which is a sectional view through an illuminated display system according to the invention, FIG. 2 which is an embodiment of a stochastic random markings pattern on one surface of the light transmitting sheet, FIG. 3 which is an embodiment of suitable dot matrix printing on one surface of the light transmitting sheet, FIG. 4 which shows a comparison of light output vs position across the sign for a printed gloss sheet versus a printed rough surface sheet (both sheets printed with the same pattern) and FIG. 5 which shows a comparison of roughened surface sheet with printing on the opposed side versus simple printed sheet by means of light output vs position across the sign.

In FIG. 1 the light transmitting sheet (10) is a 945×865×10 mm clear cast polymethylmethacrylate (PMMA) which has been treated by screen printing white markings (20) directly on to the rear surface (11) after having a rough surface formed on its light output surface (12). The markings are printed on to the rear surface as shown in FIGS. 2 (stochastic) and 3 (array of dot markings). The randomly printed stochastic markings range from 0.3 to 3 mm in length whereas the dots of FIG. 3 are all of equal size and equally spaced. The light sources are Philips TLD 30W/865 FA30 fluorescent tubes (13, 14) which both have a power output of 30 Watts, a colour rendering value (Ra) of 86, a colour temperature of 6500 Kelvin and a diameter of 25 mm. These are each placed adjacent to an edge of the light transmitting sheet and surrounded by a mirrored aluminium reflector (15, 16). A further reflection sheet 18 is located adjacent to and parallel with the rear surface 11 to reflect light back towards the output surface 12 (the reflection sheet is shown spaced for illustration purposes although, in use, it would abut against the opposite surface of the transmission sheet).

The surface texture of the roughened surfaces has been defined by means of a Ra parameter. ISO 4287 and 4288 describe the recommended procedures for determining Ra and other statistical parameters. Measurements were made using a TALISURF meter and were found to have an Ra in the range 0.9-1.8. Gloss measurements were made using an Erichson mini glossmeter 507-M (85e) and the equivalent gloss values for the surfaces are 14-30%. The roughness can be considered as a higher frequency surface effect superimposed on top of waviness and form. The roughness is usually described by Ra or similar parameters which is within a 101 μm vertical range. The afore mentioned ISO standards describe the recommended sampling links and cut off values for making measurements. For instance, for a periodic profile of 4 mm (upper limit of the range), the cut off value is 8 mm and sample length is 40 mm. This is for an Ra value of around 10 μm.

### EXPERIMENTAL DETAILS

The examples use a rectangular sheet of thickness range 3 mm-25 mm made from clear cast polymethylmethacrylate which has one roughened or matt surfaces. The roughened surface was made by cast polymerisation against an etched glass plate. The roughened surface is characterised by gloss measurements and by surface roughness measurements.

Gloss measurements may be made using an Erichsen Mini Glossmeter 507-M measuring the percentage of reflected light at an angle of 85 degrees.

Roughness measurements (Ra, microns) were made using a Surtronic 3P Talisurf meter supplied by Rank-Taylor-Hobson. This is calibrated against a reference tile before use. The reference used is a rough metal tileplate (6 micron) with the meter in calibration mode. The Ra of the sample is measured directly. For the samples used in the examples,

All roughened surface panels were made from acrylic cast against roughened glass. The chosen panel is placed with the rough surface uppermost in a framework that forms the sign, light sources are placed adjacent to the input edge of the panel. In the examples two light sources have been used on opposing edges of the panel.

Light output measurements are made by placing a RS Digital Lightmeter (RS 180-7133) on the surface of the sign. An array of points are measured on the surface, and points equi-distant from a tube are averaged. These averaged values are displayed graphically in FIGS. 4-5. Typically the light output with distance from one or both of the light input edges is recorded.

### Example 1

Printed Gloss Sheet -v- Printed Rough Surface Sheet

This example shows that when the ink is printed on the opposite surface of a sheet which has one rough output surface there is a much more even output than when the same amount of ink is printed on the opposite surface of a gloss sheet. The gloss sheet (gloss/print (vary)) is brighter because the light is concentrated in the central region where the dots are printed. This is not desirable as the need is for even illumination across the panel. For the rough surface/print (rough/print (vary)) a much more even output is achieved due to the use of both a rough surface and a printed region. In both cases the same, varying density dot pattern is used on the opposite surface. The variable coverage in the dot pattern is between 0-16% within any nominal area. The total dot pattern coverage in terms of ink/surface area is 5% for each sample.

### Example 2

Rough Surface/Printed vs Double Sided Printed

This example shows that with the rough surface (output side)/printed surface (opposite side) combination, much less ink is required to achieve the same output as a conventional panel (printing on both surfaces). Indeed, the rough surface/print panel has a slightly improved output overall. In this example, it is calculated that the Prismex panel has 2.8 times as much ink printed on it as the rough surface/printed panel.

The dot pattern in the nominal area of the conventional panel is 3-16% on each side. For the rough surface/print surface example, the variable coverage in any nominal area is between 0-16%. The total coverage across the whole surface for the conventional panel is 7% per side and the printed side of the example of the invention is 5%.

The reader's attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extend to any novel one, or any novel combination, of the features disclosed in this specification (including any accompanying claims, abstract and drawings), or to any novel one, or any novel combination, of the steps of any method or process so disclosed.

1. An edge lit illumination device comprising at least one light source; a light transmission member having at least one light output surface and at least one light ingress edge substantially perpendicular to said surface, the light source being located adjacent to said light ingress edge so that the light from the light source enters the transmission member via the said edge and propagates through the said member, the said at least one light output surface being uniformly roughened across the output surface, wherein the surface of the said member opposite the output surface has a pattern of light diffusing elements thereon.

2. An edge lit illumination device according to claim 1, wherein the said surface of the opposite side of the light transmitting sheet has light diffusing elements as a pattern of discrete markings extending across the surface thereof.

3. An edge lit illumination device according to claim 2, wherein the markings extend across all of the said surface.

4. An edge lit illumination device according to claim 2, wherein the markings extend across a part of the said surface.

5. An edge lit illumination device according to claim 2, wherein the level of surface area coverage by the discrete markings on the said opposite side surface is 0.1 to 99% of the total opposite surface area.

6. An edge lit illumination device according to claim 2, wherein the density of markings is increased in a direction away from the edge of the light transmitting sheet at which the light source is positioned.

7. An edge lit illumination device according to claim 2, wherein markings may be etched, painted or screen printed directly on to the surface of the light transmitting sheet or to that of a transparent film which is itself then adhered to the surface.

8. An edge lit illumination device according to claim 2, wherein the extent of the distribution of the markings encompasses substantially all of the surface of the said opposite surface or a defined area of the surface.

9. An edge lit illumination device according to claim 1, wherein roughening is not applied to the said opposite surface.

10. An edge lit illumination device according to claim 1, wherein the surface of the opposite surface is a gloss surface.

11. A method of producing a light transmission member for an illumination device comprising the steps of:—
(a) forming the said member,
(b) applying roughening to the output surface, and
(c) applying light diffusing elements to the rear surface.

12. A method of producing a light transmission member as claimed in claim 11, wherein steps (a) and (b) are carried out simultaneously.

13. An edge lit illumination device according to claim 1, wherein the roughening is sufficiently fine to give an average Ra value across the output surface of less than 1.0 μm/mm thickness of the element.

14. An edge lit illumination device according to claim 1, wherein the roughening is sufficiently fine to give drop-off of light output across the output surface of less than 5000 lux.

15. An edge lit illumination device according to claim 1, wherein in addition to roughening of the output surface, a reflector adjacent to the opposite surface, to redirect light to an output surface is provided.

16. An edge lit illumination device according to claim 1, wherein a plurality of sheets is provided in superposed relationship.

17. An edge lit illumination device according to claim 16, wherein roughening is applied to the output faces of the superposed sheets, the inner mating faces having the light diffusing elements thereon.

18. An edge lit illumination device according to claim 1, wherein the marks are intensified in areas where light output requires intensification due to the light source position.

19-20 (canceled).
